(19) United States
(12) Patent Application Publication
(10) Pub. No.: US 2024/0145891 A1
(43) Pub. Date: May 2, 2024

(54) METHOD OF MANUFACTURING SECONDARY BATTERY

(71) Applicant: Prime Planet Energy & Solutions, Inc., Tokyo (JP)

(72) Inventors: Takehiro OGURA, Kobe-shi (JP); Yusuke TOMIMATSU, Himeji-shi (JP); Ryoichi WAKIMOTO, Kobe-shi (JP)

(21) Appl. No.: 18/476,313

(22) Filed: Sep. 28, 2023

(30) Foreign Application Priority Data
Oct. 28, 2022 (JP) 2022-173415

(51) Int. Cl. H01M 50/636; H01M 10/0587

(52) U.S. Cl. CPC H01M 50/636; H01M 10/0587

(57) ABSTRACT

A method of manufacturing a secondary battery of a present disclosure includes a sealing step. At the sealing step, regarding a first area pressed by a pressing jig on a center in width directions of a pair of first side walls, a second area positioned at a sealing plate side more than the first area, and a third area positioned at a bottom part side more than the first area, in a case where distances in a thickness direction of the battery case directed from an outer surface of one of the first side walls toward an outer surface of the other one of the first side walls are respectively treated as T1, T2, and T3, the pair of first side walls are pressed by a pressing jig to make maximum values of them satisfy T2>T3>T1 to seal a liquid injection hole.

### CROSS REFERENCE TO RELATED APPLICATIONS

This application claims the benefit of priority to Japanese Patent Application No. 2022-173415 filed on Oct. 28, 2022. The entire contents of this application are hereby incorporated herein by reference.

### BACKGROUND

The present disclosure relates to a method of manufacturing a secondary battery.

Conventionally, it is known about a secondary battery that includes an electrode assembly including a positive electrode and a negative electrode, an electrolyte solution, and a battery case configured to accommodate the electrode assembly and the electrolyte solution. Related to this, for example, Japanese Patent Application Publication No. 2010-21104 discloses a method of manufacturing the secondary battery that performs a charging step, a degassing step, and an aging step, under a restricted state where a pair of wide width surfaces of the battery case are sandwiched from both sides and the battery case is pressed in the sandwiched direction.

### SUMMARY

Based on examination of the present inventor, the technique described above has been supposed to have a room for further improvement. As described in detail, regarding the pressing method of the battery case in accordance with the above-described technique, a swell suppress with respect to a height direction of the battery case (vertical direction) is not considered. In other words, the pressing method of the above-described technique includes some fears of increasing the height of the battery case in response to the bottom part of the battery case being expanded.

A present disclosure has been made in view of the above described circumstances, and the object is to provide a method of manufacturing the secondary battery that can not only suppress convex-shaped expansion of the battery case due to gas generation caused by charge and discharge of the secondary battery but also suppress increase of the height of the battery case at the time of making the battery case be pressed.

The present disclosure is a method of manufacturing a secondary battery that includes an electrode assembly including a positive electrode and a negative electrode, includes an electrolyte solution, and includes a battery case configured to accommodate the electrode assembly and the electrolyte solution. The battery case includes an exterior body including an opening, a bottom part, a pair of first side walls, and a pair of second side walls whose area sizes are respectively smaller than the first side walls, and includes a sealing plate configured to seal the opening, and then a thickness of the sealing plate is larger than a thickness of the bottom part. The method of manufacturing the secondary battery described above includes a liquid injection step at which the electrolyte solution is injected from a liquid injection hole provided on the sealing plate to an inside of the battery case, a charging step at which charging is performed, and a sealing step at which the liquid injection hole is sealed under a state where pressing is performed by a pressing jig on the pair of first side walls from both sides. Here, at the sealing step, in a case where an area pressed by the pressing jig in a center with respect to width directions of the pair of first side walls is treated as a first area, an area positioned at a side of the sealing plate more than the first area is treated as a second area, an area positioned at a side of the bottom part more than the first area is treated as a third area, and distances of the first area, the second area, and the third area in a thickness direction of the battery case directed from an outer surface of one of the first side walls toward an outer surface of the other one of the first side walls are respectively treated as T1, T2, and T3, the battery case is deformed by the pressing so as to make respective maximum values of the T1, the T2, and the T3 satisfy a relation below: T2>T3>T1.

According to the manufacturing method described above, the pressing jig is configured to press the first side wall of the battery case. Furthermore, a thickness of the sealing plate is larger than a thickness of an exterior body bottom part. Thus, even when the pressing jig is used to press the battery case so as to swell the second area, the sealing plate is hardly deformed. In other words, it is possible not only to suppress the battery case from being damaged, but also to suppress the height of the battery case from increasing (in other words, exterior body bottom part from protruding downwardly). Then, by the press described above, the liquid injection hole is sealed in a state where an inner capacity of the battery case is reduced. Thus, it is possible to suppress the battery case from being expanded in the convex shape due to the gas generation caused by the charge and discharge of the secondary battery.

### BRIEF DESCRIPTION OF THE DRAWINGS

FIG. 1 is a perspective view that schematically shows a battery in accordance with one embodiment.

FIG. 2 is a longitudinal cross section view that is schematically shown along a II-II line of FIG. 1.

FIG. 3 is a longitudinal cross section view that is schematically shown along a III-III line of FIG. 1.

FIG. 4 is a schematic view that shows a configuration of an electrode assembly in accordance with one embodiment.

FIG. 5 is a longitudinal cross section view that schematically shows a sealing step in accordance with a first embodiment.

FIG. 6 is a longitudinal cross section view that schematically shows the sealing step in accordance with a second embodiment.

FIG. 7 is a longitudinal cross section view that schematically shows the sealing step in accordance with a third embodiment.

### DETAILED DESCRIPTION

Below, while referring to drawings, embodiments in accordance with a present disclosure will be explained. A matter not described in the present specification but required for performing the present disclosure can be grasped as design matters of those skilled in the art based on the related art in the present field. The present disclosure can be executed based on the contents disclosed in the present specification, and the technical common sense in the present field. In addition, in the following accompanying drawings, the same numerals and signs are given to the members/parts providing the same effect. Additionally, in each drawing the dimensional relation (length, width, thickness, or the like) does not reflect the actual dimensional relation. A numerical value range expressed as “A to B” in the present specification semantically includes A and B, and semantically covers meanings of “preferably more than A” and “preferably less than B”.

In the present specification, the “battery” is a term widely denoting an electric storage device from which an electric energy can be taken out, and is a concept containing the primary battery and the secondary battery. In the present specification, the “secondary battery” represents a general electric storage device that can be repeatedly charged and discharged by making charge carriers move between a positive electrode and a negative electrode via an electrolyte solution. The secondary battery semantically covers a so-called storage battery (chemical battery), such as lithium-ion secondary battery and nickel hydrogen battery. Below, embodiments will be described in a case where the lithium-ion secondary battery is treated as a target.

<Secondary Battery 100>

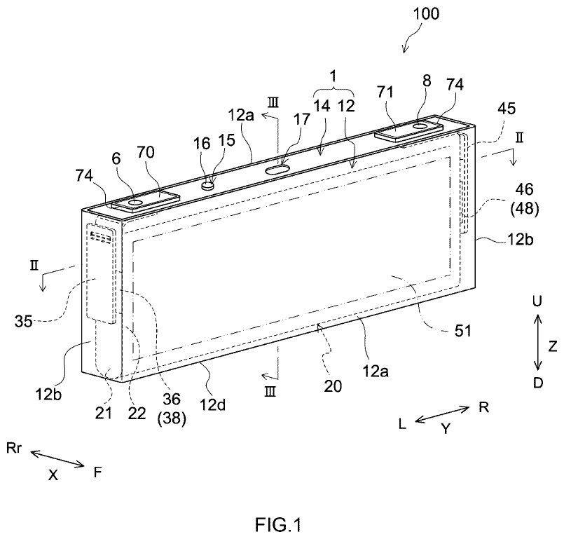

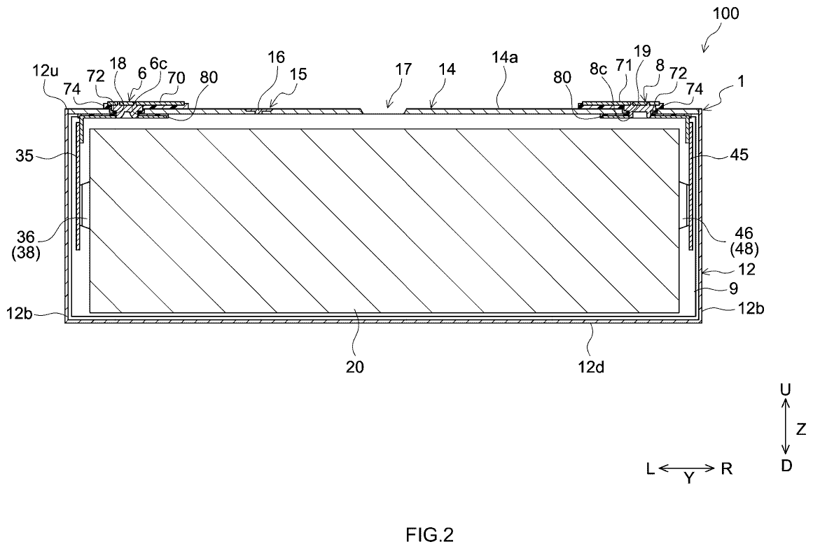

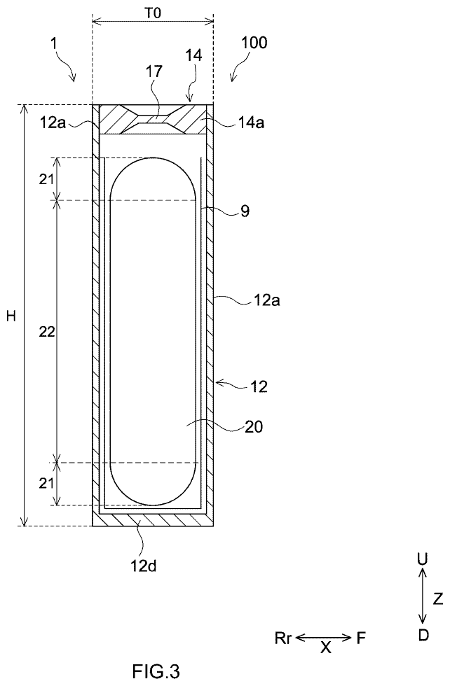

FIG. 1 is a perspective view that schematically shows a secondary battery 100 in accordance with a first embodiment. FIG. 2 is a longitudinal cross section view that is schematically shown along a II-II line of FIG. 1. FIG. 3 is a longitudinal cross section view that is schematically shown along a III-III line (center in a long side direction Y of a first side wall 12a) of FIG. 1. In explanation described below, reference signs L, R, F, Rr, U, and D in figures respectively represent left, right, front, rear, up, and down. Additionally, in figures, a reference sign X represents a short side direction of the secondary battery 100 (which may be referred to as a thickness direction), a reference sign Y represents a long side direction of the secondary battery 100, a reference sign Z represents a vertical direction of the secondary battery 100 (which may be referred to as a height direction). However, these are merely directions for convenience sake of explanation, which never restrict the disposed form of the secondary battery 100. Here, for convenience sake of explanation, in FIG. 1, a first area 51 is represented with an imaginary line.

As shown in FIG. 1 and FIG. 2, the secondary battery 100 includes a battery case 1, an electrode assembly 20, a positive electrode terminal 6, a negative electrode terminal 8, a positive electrode collecting member 35, and a negative electrode collecting member 45. As the illustration is omitted, the secondary battery 100 further includes an electrolyte solution. It is preferable that the secondary battery 100 is a nonaqueous electrolyte secondary battery, such as lithium-ion secondary battery.

The battery case 1 is a housing configured to accommodate the electrode assembly 20. As shown in FIG. 1, the battery case 1 herein has an outer appearance that is formed in a flat and bottomed rectangular parallelopiped shape (square shape). A material of the battery case 1 may be the same as a material conventionally used, and is not particularly restricted. It is preferable that the battery case 1 is made of metal, and it is more preferable that the battery case is made of aluminum or aluminum alloy. As shown in FIG. 1 and FIG. 2, the battery case 1 includes an exterior body 12 having an opening 12u and includes a sealing plate 14 configured to seal the opening 12u. Each of the exterior body 12 and the sealing plate 14 has a volume based on an accommodated number of the electrode assemblies 20 (one or multiple, one in this embodiment), a size, or the like.

The exterior body 12 is, as shown in FIG. 1 and FIG. 2, a container that has the opening 12u at the upper surface and that is formed in a bottomed square shape. The exterior body 12 includes, as shown in FIG. 1, a bottom part 12d, a pair of first side walls (large area size side wall) 12a extending upward from long sides of the bottom part 12d and being opposed mutually, and a pair of second side walls (small area size side wall) 12b extending upward from short sides of the bottom part 12d and being opposed mutually. The bottom part 12d is formed in an approximately rectangular shape. An area size of the first side wall 12a is larger than an area size of the second side wall 12b. The bottom part 12d is opposed to the opening 12u (see FIG. 2).

The sealing plate 14 is a plate-shaped member formed in a flat surface approximately rectangular shape, which is attached to the exterior body 12 so as to cover the opening 12u of the exterior body 12. As shown in FIG. 2, the sealing plate 14 includes a base part 14a and is provided with a liquid injection hole 15, a gas exhaust valve 17, and terminal taking out holes 18, 19. The base part 14a is an area where a concave and convex part is not formed in a vertical direction Z, in other words, where a thickness of the sealing plate 14 is approximately uniform. The sealing plate 14 is opposed to the bottom part 12d of the exterior body 12. The battery case 1 is integrated by making the sealing plate 14 be joined (for example, by welding) to a peripheral edge of the opening 12u of the exterior body 12. Thus, the battery case 1 is airtightly (hermetically) sealed.

The liquid injection hole 15 is a penetration hole that is configured for injecting the electrolyte solution to an inside of the battery case 1 after the sealing plate 14 is assembled to the exterior body 12. The liquid injection hole 15 herein is sealed by a sealing member 16 after the electrolyte solution is injected. The gas exhaust valve 17 is a thin-walled part that is configured to be broken when a pressure inside the battery case 1 becomes equal to or more than a predetermined value, so as to exhaust the gas inside the battery case 1 to an outside. As a material of the sealing member 16, it is possible to use a sealing member utilized for this kind of secondary battery, without particular restriction. The sealing member 16 is configured, for example, with only a metal member, or with a metal member and a seal member (resin).

As the electrolyte solution, one utilized for a conventionally known battery can be used without particular restriction. As one example, a nonaqueous electrolyte solution is preferably used in which a supporting salt (electrolyte salt) is dissolved into a nonaqueous type solvent (organic solvent). As one example of the nonaqueous type solvent, it is possible to use a carbonate type solvent, such as ethylene carbonate, dimethyl carbonate, and ethyl methyl carbonate. As one example of the supporting salt, it is possible to use a fluorine-containing lithium salt, such as LiPF₆. The electrolyte solution may contain an additive agent, as needed.

The positive electrode terminal 6 is attached to one of the end parts (left end part in FIG. 1 and FIG. 2) in a long side direction Y of the sealing plate 14. The negative electrode terminal 8 is attached to the other one of the end parts (right end part in FIG. 1 and FIG. 2) in the long side direction Y of the sealing plate 14. As shown in FIG. 2, the positive electrode terminal 6 and the negative electrode terminal 8 are respectively inserted into the terminal taking out holes 18, 19 and are configured to be exposed to a surface at an outer side of the sealing plate 14. As shown in FIG. 2, a lower end part 6c of the positive electrode terminal 6 is electrically connected to the positive electrode 3 of the electrode assembly 20 via the positive electrode collecting member 35 inside the exterior body 12. A lower end part 8c of the negative electrode terminal 8 is electrically connected to the negative electrode 4 of the electrode assembly 20 via the negative electrode collecting member 45 inside the exterior body 12. The positive electrode terminal 6 and the negative electrode terminal 8 are insulated, by a gasket 72 and an insulating member 80, from the sealing plate 14. In addition, between the positive electrode terminal 6 and the positive electrode collecting member 35, or between the negative electrode terminal 8 and the negative electrode collecting member 45, a current interrupt device (CID) may be disposed.

The positive electrode terminal 6 is electrically connected, at an outer side of the battery case 1, to a positive electrode outside conductive member 70 formed in a plate shape. The negative electrode terminal 8 is electrically connected, at the outer side of the battery case 1, to a negative electrode outside conductive member 71 formed in a plate shape. The positive electrode outside conductive member 70 and the negative electrode outside conductive member 71 are connected to another secondary battery or an outside equipment via an outside connecting member, such as bus bar. It is preferable that the positive electrode outside conductive member 70 and the negative electrode outside conductive member 71 are configured with a metal outstanding for an electrically conductive property, and they may be configured, for example, with aluminum, aluminum alloy, copper, copper alloy, or the like. The positive electrode outside conductive member 70 and the negative electrode outside conductive member 71 are insulated by an outside resin member 74 from the sealing plate 14. However, the positive electrode outside conductive member 70 and the negative electrode outside conductive member 71 are not essential, and may be omitted in another embodiment.

It is preferable that the positive electrode terminal 6 is made of metal, and it is more preferable that the positive electrode terminal is made of, for example, aluminum or aluminum alloy. It is preferable that the negative electrode terminal 8 is made of metal, and it is more preferable that the negative electrode terminal is made of, for example, copper or copper alloy. The negative electrode terminal 8 may be configured by making 2 conductive members be joined and integrated. For example, a portion connected to the negative electrode collecting member 45 may be made of copper or copper alloy, and a portion exposed to a surface at the outer side of the sealing plate 14 may be made of aluminum or aluminum alloy.

A number of the electrode assemblies 20 arranged inside one exterior body 12 is not particularly restricted, and may be 2 or more (plural). As shown in FIG. 2 and FIG. 3, the electrode assembly 20 herein is arranged inside the exterior body 12 under a state of being covered by an insulation sheet 9 (electrode assembly holder). For example, the insulation sheet 9 is folded and bent so as to be formed in a box shape, and then the electrode assembly 20 is arranged inside the insulation sheet 9. Thus, it is possible to inhibit the electrode assembly 20 from directly coming into contact with the exterior body 12. It is preferable that the insulation sheet 9 is made of resin.

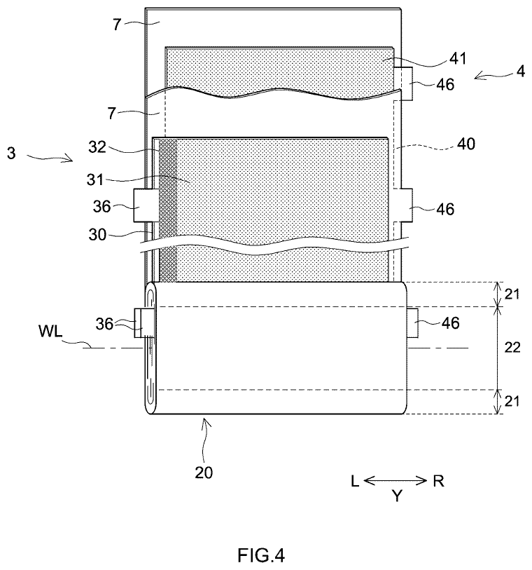

FIG. 4 is a schematic view that shows a configuration of the electrode assembly 20. As shown in FIG. 4, the electrode assembly 20 includes the positive electrode 3 and the negative electrode 4. It is preferable that the electrode assembly 20 is formed in a flat shape. As shown in FIG. 4, it is preferable that the electrode assembly 20 is configured by laminating the positive electrode 3 formed in a strip-like shape and the negative electrode 4 formed in a strip-like shape under a state where the positive electrode and the negative electrode are arranged via the separator 7 formed in a strip-like shape so as to be insulated, and by winding the resultant with a wound axis WL treated as a center so as to be a wound electrode assembly formed in a flat shape.

As shown in FIG. 3, the electrode assembly 20 includes a pair of curved portions 21 opposed to the bottom part 12d of the exterior body 12 and the sealing plate 14, and includes a flat portion 22 configured to couple the pair of curved portions 21 and opposed to the first side wall 12a of the exterior body 12. However, the electrode assembly 20 may be a laminate electrode body in which plural square shaped (typically, rectangular) positive electrodes and plural square shaped (typically, rectangular) negative electrodes are stacked in a state of being insulated.

As shown in FIG. 4, the positive electrode 3 includes a positive electrode collecting body 30, a positive electrode active material layer 31 fixed on at least one of surfaces of the positive electrode collecting body 30, and a positive electrode protective layer 32. However, the positive electrode protective layer 32 is not essential, and may be omitted in another embodiment. The positive electrode collecting body 30 is, for example, made of an electrically conductive metal, such as aluminum, aluminum alloy, nickel, and stainless steel, and it is preferable that the positive electrode collecting body is made of aluminum or aluminum alloy. The positive electrode active material layer 31 is a layer containing a positive electrode active material (for example, lithium transition metal composite oxide, such as lithium-nickel-cobalt-manganese composite oxide) that can reversibly store and release a charge carrier. The positive electrode protective layer 32 is, for example, a layer containing an inorganic filler, such as alumina.

As shown in FIG. 4, the negative electrode 4 includes a negative electrode collecting body 40 and a negative electrode active material layer 41 fixed on the negative electrode collecting body 40. The negative electrode collecting body 40 is, for example, made of an electrically conductive metal, such as copper, copper alloy, nickel, and stainless steel, and it is preferable that the negative electrode collecting body is made of copper or copper alloy. The negative electrode active material layer 41 is a layer containing a negative electrode active material (for example, carbon material, such as graphite) that can reversibly store and release the charge carrier.

At one of end parts (left end part in FIG. 4) in the long side direction Y of the positive electrode collecting body 30, plural positive electrode tabs 36 are provided. The plural positive electrode tabs 36 protrude toward one side (left side in FIG. 4) of the long side direction Y. The plural positive electrode tabs 36 protrude more than the separator 7 in the long side direction Y. Each of the plural positive electrode tabs 36 herein is formed in a trapezoidal shape. However, the shape of the positive electrode tab 36 is not restricted to this example. In addition, each size of the plural positive electrode tabs 36 is not particularly restricted, either. The shape or size of the positive electrode tab 36 can be suitably adjusted, for example, in consideration of a state of being connected to the positive electrode collecting member 35, and based on a formed position, or the like. It is preferable that the positive electrode tab 36 is made of a metal foil, or further preferable that the positive electrode tab is made of an aluminum foil or an aluminum alloy foil. Here, the positive electrode tab 36 is a portion of the positive electrode collecting body 30 where the positive electrode active material layer 31 and the positive electrode protective layer 32 are not formed (so called, an electrical collector body exposed part). However, the positive electrode tab 36 may be a member different from the positive electrode collecting body 30.

At the other one of the end parts (right end part in FIG. 4) in the long side direction Y of the negative electrode collecting body 40, plural negative electrode tabs 46 are provided. The plural negative electrode tabs 46 protrude toward one side (right side in FIG. 4) of the long side direction Y. The plural negative electrode tabs 46 protrude more than the separator 7 in the long side direction Y. Each of the plural negative electrode tabs 46 is formed in a trapezoidal shape. However, the shape of the negative electrode tab 46 is not restricted to this example. In addition, each size of the plural negative electrode tabs 46 is particularly restricted, either. The shape or size of the negative electrode tab 46 can be suitably adjusted, for example, in consideration of a state of being connected to the negative electrode collecting member 45, and based on a formed position, or the like. It is preferable that the negative electrode tab 46 is made of a metal foil, or further preferable that the negative electrode tab is made of a copper foil or a copper alloy foil. Here, the negative electrode tab 46 is a portion of the negative electrode collecting body 40 where the negative electrode active material layer 41 is not formed (so called, the electrical collector body exposed part). However, the negative electrode tab 46 may be a member different from the negative electrode collecting body 40.

The separator 7 is a member configured to establish an insulation between the positive electrode active material layer 31 of the positive electrode 3 and the negative electrode active material layer 41 of the negative electrode 4. As the separator 7, it is suitable, for example, to use a porous resin-made sheet consisting of a polyolefin resin, such as polyethylene (PE) and polypropylene (PP). Incidentally, on a surface of the separator 7, a heat resistance layer (HRL) containing an inorganic filler may be provided.

As shown in FIG. 2, the plural positive electrode tabs 36 are laminated at one of end parts (left end part in FIG. 2) in the long side direction Y, so as to configure a positive electrode tab group 38. On the other hand, the plural negative electrode tabs 46 are laminated at other of the end parts (right end part in FIG. 2) in the long side direction Y, so as to configure a negative electrode tab group 48. Here, the secondary battery 100 has a so-called lateral tab structure in which the positive electrode tab group 38 and the negative electrode tab group 48 are respectively positioned at left and right of the electrode assembly 20. However, the secondary battery 100 may have a so-called upward tab structure in which the positive electrode tab group 38 and the negative electrode tab group 48 are respectively positioned at upper and lower of the electrode assembly 20. The positive electrode tab group 38 is bent in a state of being joined to the positive electrode collecting member 35. Similarly, the negative electrode tab group 48 is bent in a state of being joined to the negative electrode collecting member 45.

The positive electrode collecting member 35 configures a conduction path that electrically connects the positive electrode tab group 38 of the electrode assembly 20 and the positive electrode terminal 6. It is preferable that the positive electrode collecting member 35 is configured with a metal outstanding for an electrically conductive property, and that the positive electrode collecting member is, for example, configured with aluminum or aluminum alloy. The negative electrode collecting member 45 configures a conduction path that electrically connects the negative electrode tab group 48 of the electrode assembly 20 and the negative electrode terminal 8. It is preferable that the negative electrode collecting member 45 is configured with a metal outstanding for an electrically conductive property, and that the negative electrode collecting member is, for example, configured with copper or copper alloy.

<Method of Manufacturing Secondary Battery 100>

A method of manufacturing the secondary battery 100 disclosed herein is characterized by including a liquid injection step, a charging step, and a sealing step. The method of manufacturing the secondary battery 100 disclosed herein may further include, in addition to the above-described steps, another step at an arbitrary stage. Although not particularly restricted, for example, it is possible to manufacture it by a manufacturing method including (1) assembly preparing step, (2) drying step, (3) liquid injection step, (4) charging step, (5) decompressing step, and (6) sealing step, typically in this order. The method of manufacturing the secondary battery disclosed herein is characterized by including the sealing step, and the other manufacturing processes may be similar to conventional processes.

(1) Assembly Preparing Step

At the assembly preparing step, the electrode assembly 20 is arranged inside the battery case 1 (exterior body 12) so as to prepare the battery assembly. Incidentally, the term “battery assembly” in the present specification represents a secondary battery assembled to be a form before the charging step described later.

For example, the battery case 1 (sealing plate 14 and exterior body 12), the electrode assembly 20, the positive electrode terminal 6, the negative electrode terminal 8, the positive electrode collecting member 35, the negative electrode collecting member 45, and the insulation sheet 9 are prepared. It is preferable that the electrode assembly 20 is a wound electrode assembly in which the positive electrode and the negative electrode are wound via the separator so as to be formed in a flat shape, as described above. The electrode assembly 20 can be manufactured by a conventionally known method. The herein disclosed secondary battery 100 is characterized by including the battery case 1 (exterior body 12 and sealing plate 14), and the other configurations may be similar to conventional configurations.

The exterior body 12 prepared at the assembly preparing step is made of metal, and preferably made of aluminum or aluminum alloy. It is preferable that a thickness of the first side wall 12a is smaller than a thickness of the second side wall 12b. A thickness of the first side wall 12a is preferably equal to or more than 0.2 mm, further preferably equal to or more than 0.4 mm, or furthermore preferably equal to or more than 0.6 mm. On the other hand, a thickness of the first side wall 12a is preferably equal to or less than 1.5 mm, further preferably equal to or less than 1.1 mm, or further preferably equal to or less than 0.9 mm. A width of the first side wall 12a is preferably equal to or more than 15 cm, or further preferably equal to or more than 20 cm. A height of the first side wall 12a is preferably equal to or more than 5 cm, or further preferably equal to or more than 8 cm. Incidentally, the wording “width of the first side wall 12a” represents a length of the first side wall 12a in the long side direction Y, and the wording “height of the first side wall 12a” represents a length of the first side wall 12a in the vertical direction Z. A thickness of the bottom part 12d is preferably equal to or more than 1.0 mm, further preferably equal to or more than 1.3 mm, or further preferably equal to or more than 1.5 mm. On the other hand, a thickness of the bottom part 12d is preferably equal to or less than 2.5 mm, further preferably equal to or less than 2.1 mm, or furthermore preferably equal to or less than 1.9 mm. According to the exterior body 12 having the above-described configuration, at the later-described sealing step, the first side wall 12a of the exterior body 12 becomes easily deformed. Accordingly, it is possible to further effectively suppress the height H of the battery case 1 in the vertical direction from being increased.

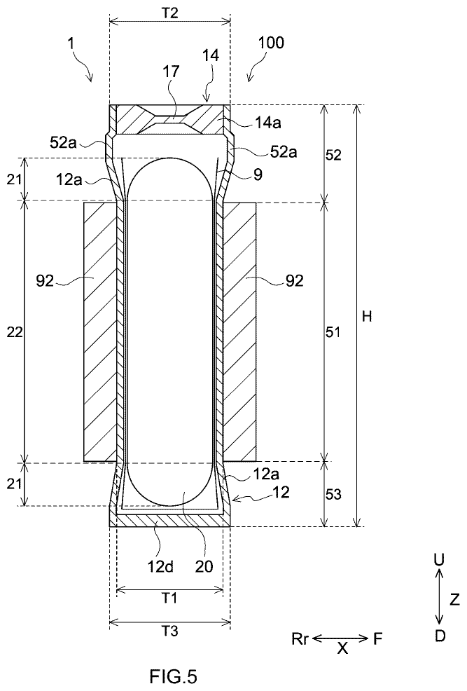

The sealing plate 14 prepared at the assembly preparing step is made of metal, and preferably made of aluminum or aluminum alloy. As shown in FIGS. 3 and 5, a thickness of the base part 14a of the sealing plate 14 is larger than a thickness of the bottom part 12d of the exterior body 12. Thus, it is possible to make the sealing plate 14 have a strength to some extent, and to suppress the height H of the battery case 1 in the vertical direction from being increased. In addition, for enhancing a quality of a join part of the exterior body 12 and the sealing plate 14, it is preferable to enlarge the thickness of the sealing plate 14. The thickness of the base part 14a of the sealing plate 14 is preferably equal to or more than 1.5 mm, further preferably equal to or more than 2.0 mm, or furthermore preferably equal to or more than 2.5 mm. On the other hand, the thickness of the base part 14a of the sealing plate 14 is preferably equal to or less than 4.0 mm, preferably equal to or less than 3.0 mm, or furthermore preferably equal to or less than 2.9 mm. Incidentally, the wording “thickness of the base part 14a of the sealing plate 14” represents “thickness of the sealing plate 14” in the present specification. According to the sealing plate 14 including the above-described configuration, after the later-described sealing step, not only the deformation of the sealing plate 14 is inhibited, but also the first side wall 12a of the exterior body 12 is further suitably made to become easily deformed. Accordingly, it is possible to further effectively suppress the height H of the battery case 1 in the vertical direction from being increased.

It is preferable that materials of the exterior body 12 and the sealing plate 14 are the same kind of materials, and it is in fact particularly preferable that they are configured with metals in which aluminum is the main component (for example, aluminum content rate is equal to or more than 85 mass %). However, the materials of the exterior body 12 and the sealing plate 14 may be different from each other.

At the assembly preparing step, the positive electrode collecting member 35 is attached to the positive electrode tab group 38 of the electrode assembly 20, and furthermore the negative electrode collecting member 45 is attached to the negative electrode tab group 48. Then, the positive electrode terminal 6 and the negative electrode terminal 8 are attached to the sealing plate 14. To these electrode terminals, the electrode collecting members of the same polarities are respectively joined by a conventionally known method (for example, ultrasonic joining, resistance welding, laser welding, or the like). Then, the electrode assembly 20 is accommodated in the insulation sheet 9. Then, it is preferable that the electrode assembly 20 covered with the insulation sheet 9 is accommodated (inserted) into an internal space of the exterior body 12. Then, by joining the exterior body 12 of the battery case 1 and the sealing plate 14, the battery assembly is manufactured. The joining operation described above can be performed, for example, by welding, such as laser welding.

It is preferable that, at the assembly preparing step, the electrode assembly 20 is arranged inside the exterior body 12 while the wound axis WL is made to be parallel to the bottom part 12d of the exterior body 12. Furthermore, it is preferable that the electrode assembly 20 is arranged inside the exterior body 12 to make the thickness (laminate) direction of the electrode assembly 20 be a direction approximately perpendicular to the first side wall 12a (direction orthogonal to the first side wall 12a). In other words, the battery case 1 is arranged inside the electrode assembly 20 in a direction (short side direction X) where the thickness direction of the battery case 1 and the thickness direction of the electrode assembly 20 coincide with each other. Thus, it becomes easy to generate a gap between the first side wall 12a and the curved surface part 21 of the electrode assembly 20, and thus the battery case 1 (exterior body 12) can be made to become easily deformed into an intended shape.

(2) Drying Step

At the drying step, by drying the battery assembly, a moisture contained in the battery assembly (for example, inside of the electrode assembly 20, or the like) is removed. As the drying method described above, it is possible to use a well-known method. For example, the drying step can be performed by carrying the battery assembly (battery case 1 in which the electrode assembly 20 is accommodated) to a drying furnace (not shown) and then by heating it.

A drying temperature and a drying time at the drying step can be suitably adjusted on the basis of a moisture contained in the electrode assembly 20, or the like. The drying temperature is not particularly restricted if the drying temperature is within a range in which the moisture can be removed, but it is desirable to perform the drying operation at the temperature which does not damage the separator 7 of the electrode assembly 20. In addition, the drying step may be performed under an atmospheric environment, or may be performed under a reduced-pressure environment, but it is preferable that the drying step is performed under the reduced-pressure environment. Thus, it is possible to shorten the drying time at the drying step. Incidentally, regarding the present disclosure, the drying step is not an essential step. In some preferred embodiments, the drying step may be omitted.

(3) Liquid Injection Step

At the liquid injection step, from the liquid injection hole 15 provided on the sealing plate 14, the electrolyte solution is injected into the battery case 1 in which the electrode assembly 20 is accommodated. The liquid injection step may be performed under the atmospheric environment, or may be performed under the reduced-pressure atmosphere, but it is preferable that the liquid injection step is performed under the reduced-pressure atmosphere. Thus, it is possible to enhance an impregnation property of the electrolyte solution into the electrode assembly 20 so as to perform the liquid injection step in a short time. At the liquid injection processing, the electrolyte solution is injected to reach a quantity of the electrolyte solution at which the electrolyte solution is spread all over the electrode assembly 20. At the liquid injection step, it is possible to suitably use a conventionally known electrolyte solution liquid injection apparatus. Incidentally, at that time, as a pressure feeding gas capable of being utilized for performing pressure feeding operation on the electrolyte solution, it is possible to use an inert gas, such as nitrogen (N₂), a dry air, or the like, similarly to a conventional one. It is preferable that, after the liquid injection step, pressurizing and decompressing are suitably performed on the inside of the battery case 1.

(4) Charging Step

At the charging step, charging is performed on the battery assembly. By performing the charging step, it is possible to form a good coating film on a surface of the negative electrode active material layer 41. The gas generated at the charging step is released to an outside of the battery case 1. A charging condition of the charging step is not particularly restricted, and may be similar to a conventional secondary battery manufacturing method. At the charging step, the liquid injection hole 15 may be temporarily sealed. However, at the charging step, the liquid injection hole 15 is not completely sealed.

(5) Decompressing Step

At the decompressing step, by decompressing the inside of the battery case 1, it is possible to exhaust the gas (for example, air, gas generated at the charging step, or the like), existing inside the battery case 1, further to the outside of the battery case 1. The decompressing step may be similar to a conventional decompressing step performed in this kind of battery manufacturing method, and does not particularly characterize the present disclosure, and thus explanation for the decompressing step in more detail is omitted. Incidentally, regarding the present disclosure, the decompressing step is not an essential step. In some preferred embodiments, it is possible to omit the decompressing step.

(6) Sealing Step

At the sealing step, a pressing jig 92 is used to seal the liquid injection hole 15 under a state where the first side wall 12a of the exterior body 12 is pressed from both sides. The sealing step includes (6-1) exterior body pressing step and (6-2) liquid injection hole sealing step in this order. Incidentally, before or after the sealing step (before the exterior body pressing step, or after the liquid injection hole sealing step), an aging step may be included. This aging step may be similar to a conventional aging step performed in this kind of battery manufacturing method, and does not particularly characterize the present disclosure, and thus explanation for the aging step in more detail is omitted.

(6-1) Exterior Body Pressing Step

FIG. 5 is a longitudinal cross section view that schematically shows the sealing step (exterior body pressing step) in accordance with a first embodiment and is a FIG. 3 correspondence diagram. At the exterior body pressing step, firstly, the pressing jig 92 is arranged to sandwich the pair of first side walls 12a of the exterior body 12 from both sides. Then, as shown in FIG. 5, a pair of pressing jigs 92 described above are used to press the pair of first side walls 12a of the exterior body 12 in a sandwiching direction (X direction in FIG. 5) of the pressing jig 92, so as to deform the battery case 1 (exterior body 12).

At the exterior body pressing step, as shown in FIG. 5, the secondary battery 100 includes a first area 51 being an area pressed by the pressing jig 92, in the center of a width direction (long side direction Y) of the first side wall 12a. On the other hand, in the vertical direction Z, the secondary battery 100 includes a second area 52 being an area positioned at the sealing plate 14 side (upper side) more than the first area 51, and includes a third area 53 being an area positioned at the bottom part 12d side (lower side) of the exterior body 12 more than the first area 51. Distances of the first area 51, the second area 52, and the third area 53 in a thickness direction X of the battery case 1 directed from an outer surface of one first side wall 12a to the other first side wall 12a are respectively referred to as T1, T2, and T3. Then, the battery case 1 (exterior body 12) is deformed to make respective maximum values satisfy the below-described formula (i): T2>T3>T1. Thus, it is possible not only to suppress the battery case 1 from being damaged, but also to suppress the height H of the battery case 1 from being increased (in other words, from protruding in a D direction of the bottom part 12d of the exterior body 12).

Described in detail, as shown in FIG. 5, regarding the first area 51, a portion abutting on the pressing jig 92 in the first side wall 12a is pushed (pressed) in an inner side (electrode assembly 20 side) direction of the exterior body 12. Thus, T1 becomes smaller than thickness T0 (see FIG. 3) of the battery case 1 before the pressing operation. Then, regarding the second area 52, an expansion part 52a is formed that protrudes from an end part of the sealing plate 14 to the outer side in the thickness direction (short side direction X) of the battery case 1. On the other hand, regarding the third area 53, the expansion part is not formed. In other words, T2 becomes larger than T3 of the third area 53 on which the expansion part is not formed, by an amount for the expansion part 52a formed on the second area. Accordingly, the below-described formula (i): T2>T3>T1; is satisfied.

A conventional manufacturing method has some fears that the bottom part 12d of the exterior body 12 may be bent and deformed in a downward convex shape, when the first side wall 12a is pressed by the pressing jig 92 to make the third area 53 be expanded. In other words, there are some fears of increasing the height H of the battery case 1. On the other hand, regarding the secondary battery 100 in accordance with the present embodiment, the thickness of the sealing plate 14 is larger than the bottom part 12d of the exterior body 12. Thus, even if pressing is performed to make the second area 52 have the expansion part 52a, it is difficult to deform the sealing plate 14. Accordingly, at the pressing time with the pressing jig 92, it is possible to suppress the height H of the battery case 1 from being increased.

At the exterior body pressing step, by using the battery case 1 (sealing plate 14 and exterior body 12) formed in the above-described shape or by controlling the press condition, it is possible to control the deformation of the battery case 1 so as to satisfy the formula (i). The press condition described above can be suitably adjusted on the basis of the shape, thickness, material, or the like, of the battery case 1. Below, a suitable press condition at the exterior body pressing step would be described in detail.

As shown in FIG. 5, regarding the pressing jig 92, one made of metal is suitably used. However, the present disclosure is not restricted to this example, for instance, a member configured with a resin, a rubber, or the like, may be arranged on a surface (in other words, area where the pressing jig 92 and the battery case 1 come into contact with each other) of the pressing jig 92.

At the exterior body pressing step, regarding the pair of first side walls 12a of the exterior body 12, when viewed along the thickness direction of the electrode assembly 20 (in a front view), in a case where a whole of area on which one of the first side walls 12a and the flat portion 22 of the electrode assembly 20 are overlapped is treated as 100%, it is preferable that the area at least equal to or more than 80% is contained in the first area 51, it is further preferable that the area equal to or more than 90% is contained in the first area, or it is furthermore preferable that the area equal to 100% is contained in the first area (see FIG. 1). In addition, the first area 51 may be larger than the area of the electrode assembly 20 overlapped with the flat portion 22, or may contain said area. In addition, it is preferable that the first area 51 in a front view contains the first side wall, and contains an area containing the positive electrode active material layer 31 on the flat portion 22 of the electrode assembly 20.

At the exterior body pressing step, regarding a ratio of the above-described distances T1, T2, and T3, it is preferable that T2/T1 is equal to or more than 1.03. It is preferable that T3/T1 is equal to or less than 1.02.

Regarding the pair of first side walls 12a of the exterior body 12, it is preferable that a pushed amount of the pressing jig 92 is set to be about 0.5 to 5 mm, or it is further preferable that the pushed amount is set to be about 0.5 to 2 mm.

Thus, at the charge and discharge time of the secondary battery 100, it is possible to suitably suppress the battery case 1 from being expanded into a convex shape. Incidentally, the term “pushed amount” in the present specification represents a difference in the short side direction X between the distance (thickness) T0 (see FIG. 3) of the battery case 1 before the pressing operation and the distance T1 (see FIG. 5) of the first area during the pressing operation (in other words, T0-T1).

At the exterior body pressing step, when the pressing jig 92 presses the first side wall 12a of the exterior body 12, it is preferable that a pressing strength (press force) is equal to or more than 5 kN, it is further preferable that the pressing strength is equal to or more than 10 kN, or it is furthermore preferable that the pressing strength is equal to or more than 20 kN. On the other hand, the pressing strength (press force) is preferably equal to or less than 40 kN, further preferably equal to or less than 35 kN, or furthermore preferably equal to or less than 30 kN.

As some suitable examples for the pressing method of the exterior body 12 (deforming method of the battery case 1) at the exterior body pressing step, embodiments are described below. However, the present disclosure is not restricted to these embodiments, and can be implemented by another method, too.

### Second Embodiment

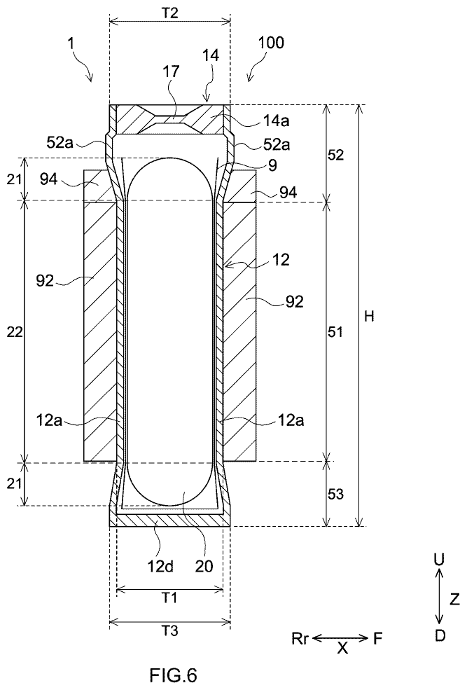

FIG. 6 is a longitudinal cross section view that schematically shows a sealing step (exterior body pressing step) in accordance with a second embodiment. As shown in FIG. 6, in the second embodiment, a first guide member 94 is arranged at a top end of the pressing jig 92. The other configurations may be similar to those of the first embodiment described above. The first guide member 94 has a role of guiding the first side wall 12a. The first guide member 94 herein is, with respect to the vertical direction Z, formed in a tapered shape whose thickness is gradually reduced toward the upward direction. The first guide member 94 and the pressing jig 92 herein are integrally formed. However, the present disclosure is not restricted to this example, for instance, the first guide member 94 and the pressing jig 92 may be individually formed and then joined by welding or the like, or they may be members different from each other. Thus, when pressing is performed with the pressing jig 92, the exterior body 12 is deformed along the tapered part of the first guide member 94. Accordingly, it becomes easy at the second area 52 to make the expansion part 52a be formed.

### Third Embodiment

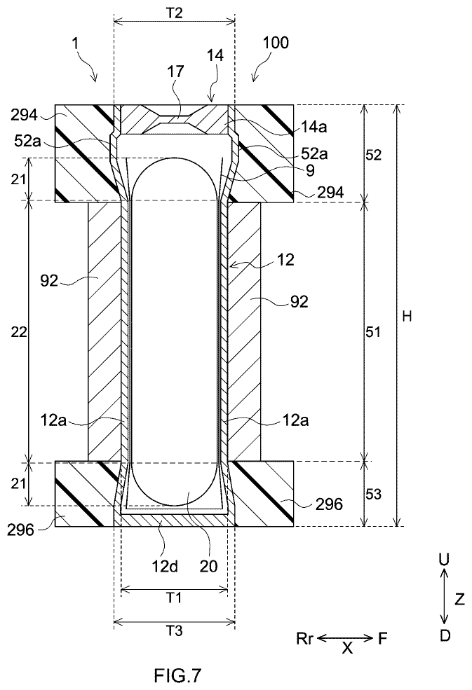

FIG. 7 is a longitudinal cross section view that schematically shows a sealing step (exterior body pressing step) in accordance with a third embodiment. As shown in FIG. 7, regarding the third embodiment, at the top end of the pressing jig 92, a first guide member 294 is arranged as a substitute for the first guide member 94. Then, at a lower end of the pressing jig 92, a second guide member 296 is provided. The other configurations may be similar to the above described second embodiment. The second guide member 296 has a role of guiding the first side wall 12a. As shown in FIG. 7, the first guide member 294 and the second guide member 296 herein are made of resin. Here, the first guide member 294 is configured to cover a whole of the second area 52. On the other hand, the second guide member 296 is configured to cover a whole of the third area 53. Thus, when the pressing jig 92 is used to press the first side wall 12a of the exterior body 12, not only the second guide member 296 can suppress the formation of the expansion part on the third area 53, but also the first guide member 294 facilitates the formation of the expansion part 52a on the second area 52.

(6-2) Liquid Injection Hole Sealing Step

At the liquid injection hole sealing step, the liquid injection hole 15 of the battery case 1 is sealed under a state where the exterior body 12 is pressed by the exterior body pressing step. Thus, the liquid injection hole 15 is sealed under a state where an inner capacity of the battery case 1 is reduced. Accordingly, it is possible to suppress the battery case 1 from being expanded into the convex shape by the gas generated at the charge and discharge time of the secondary battery 100. Here, the liquid injection hole 15 is sealed by the sealing member 16 made of metal, and the metal portion of the sealing member 16 and the battery case 1 are welded, so as to implement sealing. However, the sealing method for the liquid injection hole 15 is not restricted to this example. As the illustration is omitted, for example, a rivet, such as blind rivet, can be used to seal the liquid injection hole 15.

As described above, the method of manufacturing the secondary battery disclosed herein can not only suppress the damage of the battery case 1, but also suppress the increase in the height H of the battery case 1 so as to seal the liquid injection hole 15, and can suppress the battery case 1 from being expanded into the convex shape due to gas generation caused in response to the charge and discharge of the secondary battery 100.

Although the secondary battery 100 can be used for various purposes, typically, it can be suitably used as a power source (power supply for driving) for a motor mounted on various vehicles, such as passenger car and truck. The kind of the vehicle is not particularly restricted, but it is possible to use it, for example, on a plug-in hybrid electric vehicle (PHEV), a hybrid electric vehicle (HEV), a battery electric vehicle (BEV), or the like. In addition, the secondary battery 100 can be used suitably for construction of the battery pack.

Above, some embodiments of the present disclosure are explained, but the embodiments described above are merely examples. The present disclosure can be additionally implemented in different various forms. The present disclosure can be executed based on the contents disclosed in the present specification, and the technical common sense in the present field. The technique recited in the appended claims includes variously deformed or changed versions of the embodiments that have been illustrated above. For example, one part of the above-described embodiment can be replaced with another deformed aspect, and furthermore another deformed aspect can be added to the above described embodiment. In addition, unless a technical feature is explained to be essential, this technical feature can be appropriately deleted.

As described above, regarding aspects of the present disclosure, it is possible to recite items described below.

Item 1: A method of manufacturing a secondary battery, wherein the secondary battery comprises: an electrode assembly comprising a positive electrode and a negative electrode; an electrolyte solution; and a battery case configured to accommodate the electrode assembly and the electrolyte solution, wherein the battery case comprises: an exterior body comprising an opening, a bottom part, a pair of first side walls, and a pair of second side walls whose area sizes are respectively smaller than the first side walls; and a sealing plate configured to seal the opening, a thickness of the sealing plate is larger than a thickness of the bottom part, the method comprises: a liquid injection step at which the electrolyte solution is injected from a liquid injection hole provided on the sealing plate to an inside of the battery case; a charging step at which charging is performed; and a sealing step at which the liquid injection hole is sealed under a state where pressing is performed by a pressing jig on the pair of first side walls from both sides, and at the sealing step, in a case where an area pressed by the pressing jig in a center with respect to width directions of the pair of first side walls is treated as a first area, an area positioned at a side of the sealing plate more than the first area is treated as a second area, an area positioned at a side of the bottom part more than the first area is treated as a third area, and distances of the first area, the second area, and the third area in a thickness direction of the battery case directed from an outer surface of one of the first side walls toward an outer surface of the other one of the first side walls are respectively treated as T1, T2, and T3, the battery case is deformed by the pressing so as to make respective maximum values of the T1, the T2, and the T3 satisfy a relation below: T2>T3>T1.

Item 2: The method recited in item 1, wherein a thickness of the bottom part is 1.0 to 2.5 mm, thicknesses of the first side walls are 0.2 to 1.5 mm, and a thickness of the sealing plate is 1.5 to 4.0 mm.

Item 3: The method recited in item 1 or 2, wherein thicknesses of the first side walls are smaller than thicknesses of the second side walls.

Item 4: The method recited in any one of items 1 to 3, wherein the exterior body is constituted by aluminum or aluminum alloy, and the sealing plate is constituted by the aluminum or the aluminum alloy.

Item 5: The method according to any one of items 1 to 4, wherein each of the first side walls has a width equal to or more than 20 cm and has a height equal to or more than 8 cm.

Item 6: The method according to any one of items 1 to 5, wherein the electrode assembly is a wound electrode assembly formed in a flat shape, a wound axis of the wound electrode assembly is arranged in parallel to the bottom part of the exterior body, and a thickness direction of the wound electrode assembly is arranged to be a direction perpendicular to the first side walls.

What is claimed is:

1. A method of manufacturing a secondary battery, wherein
the secondary battery comprises:
an electrode assembly comprising a positive electrode and a negative electrode;
an electrolyte solution; and
a battery case configured to accommodate the electrode assembly and the electrolyte solution,
the battery case comprises:
an exterior body comprising an opening, a bottom part, a pair of first side walls, and a pair of second side walls whose area sizes are respectively smaller than the first side walls; and
a sealing plate configured to seal the opening,
a thickness of the sealing plate is larger than a thickness of the bottom part,
the method comprises:
a liquid injection step at which the electrolyte solution is injected from a liquid injection hole provided on the sealing plate to an inside of the battery case;
a charging step at which charging is performed; and
a sealing step at which the liquid injection hole is sealed under a state where pressing is performed by a pressing jig on the pair of first side walls from both sides,
and
at the sealing step, in a case where an area pressed by the pressing jig in a center with respect to width directions of the pair of first side walls is treated as a first area, an area positioned at a side of the sealing plate more than the first area is treated as a second area, an area positioned at a side of the bottom part more than the first area is treated as a third area, and distances of the first area, the second area, and the third area in a thickness direction of the battery case directed from an outer surface of one of the first side walls toward an outer surface of the other one of the first side walls are respectively treated as T1, T2, and T3, the battery case is deformed by the pressing so as to make respective maximum values of the T1, the T2, and the T3 satisfy a relation below: T2>T3>T1.

2. The method according to claim 1, wherein
a thickness of the bottom part is 1.0 to 2.5 mm,
thicknesses of the first side walls are 0.2 to 1.5 mm, and
a thickness of the sealing plate is 1.5 to 4.0 mm.

3. The method according to claim 1, wherein
thicknesses of the first side walls are smaller than thicknesses of the second side walls.

4. The method according to claim 1, wherein
the exterior body is constituted by aluminum or aluminum alloy, and
the sealing plate is constituted by the aluminum or the aluminum alloy.

5. The method according to claim 1, wherein
each of the first side walls has a width equal to or more than 20 cm and has a height equal to or more than 8 cm.

6. The method according to claim 1, wherein
the electrode assembly is a wound electrode assembly formed in a flat shape,
a wound axis of the wound electrode assembly is arranged in parallel to the bottom part of the exterior body, and
a thickness direction of the wound electrode assembly is arranged to be a direction perpendicular to the first side walls.
